(19) United States
(12) Patent Application Publication
(10) Pub. No.: US 2014/0089410 A1
(43) Pub. Date: Mar. 27, 2014

(54) Social Networking System and Method for Machines and Devices

(71) Applicant: Syed Umair Ahmed, Lincolnwood, IL (US)

(72) Inventor: Syed Umair Ahmed, Lincolnwood, IL (US)

(21) Appl. No.: 14/034,425

(22) Filed: Sep. 23, 2013

Related U.S. Application Data
(60) Provisional application No. 61/704,461, filed on Sep. 22, 2012.

(51) Int. Cl. H04L 29/08

(52) U.S. Cl. CPC H04L 67/10
USPC 709/204

(57) ABSTRACT

A device shares its information, such as specifications, performance details, programs and applications, usage details and service details, over a network to other devices. The network is established using social media connections of the user or similarity of device and its parts or its usage. Within the device social media network, a user views information and details of devices belonging to others within the network. The user can make decisions based on the information available to him within the social network either through known people or through recommendations. A socializing device may also take pre authorized actions to achieve usage or performance objectives.

### FIELD OF THE INVENTION

The invention relates to the social networking of machines or devices, which are socialized through a common relationship of their owners or based on similarity of machines or devices or its parts. More particularly, the present invention relates to the social networking of on-line and off-line machines of the same genre or a different genre for the sharing of information stored on the machines, to generate recommendations for users or for machines or devices to take authorized actions.

### DISCUSSION OF THE RELATED ART

A user may have several connected machines or devices that he uses on a daily basis, such as a smartphone, laptop, tablet, desktop, SmartTVs, SmartCars, connected watches, connected glasses and the like. These devices run applications and programs, including those allowing the user to participate in social networking and media. The user may wish to share information or data with friends/contacts within their social network about their connected machines or devices. Absent handing the connected machines or device to their friend or having a conversation about it, its application and programs, there is really no simple way to share information about one's connected machines or device.

Applications do exist that allow users to share some information over devices when in close proximity, and by setting up a virtual network. These actions, however, require specific software on those devices, and are not universal to all devices. Further, contacts at a distance may not be able to share information.

For example, a user purchases a new electronic tablet for his son. The user would like to find out what applications and programs that his friends have on their devices and computers applicable for children. These are trusted friends, and would mean more to the user than reviewing numerous ratings from strangers. Currently, the only way the user could do so is by looking at the devices of the friend or talking about applications in use, which may not be feasible always, or setting up a virtual link requiring passwords and special software.

For example, a user wants to purchase a new smartphone and would like to find out which smartphones are most popular in his friends circle together with device details. Currently the only way to find out popular devices in friends circle and its details is by gathering this information through a conversation.

For example, a user wants to select a Wireless network carrier for his devices and would like to get feedback and details about popular carriers in his friends circle.

### SUMMARY OF THE INVENTION

The disclosed embodiments relate to a machine social network for machines to communicate with other machines via online connections and social networking data. The disclosed embodiments and the description below use the terms “device” and “machine” interchangeably. References to a device or devices also include a machine or machines. The disclosed embodiments are not limited to devices or machines, but includes both and their equivalents. The machines may share information allowed by the end users with other machines within the social network. A software application may be installed in the appropriate machines that collect information as allowed for sharing with other machines in the online social network. Social networking may refer to the sharing of information in a trusted circle. Social networking traditionally is associated with humans, and not with machines.

Any machine that includes a processor and is able to execute software instructions may be connected to the machine social network. Even appliances include processors to relay information or store data. This information may be used over the social network of the machines. Appropriate machines, or devices, include handheld devices such mobile phones, smartphones, electronic tablets and readers, mp3 or music players, GPS devices, laptop computers, and the like. Other machines include transporting devices like automobiles, trucks, boats, planes, cycles, and the like. Appliances may include televisions, refrigerators, microwave and conventional ovens, routers, cable boxes, desktop computers, and the like.

The machine social network incorporates a centralized management login and verification page or verification through email, URL, etc., A user can manage all of his social network machines, and also configure the information shared within the network. Only allowed information will be made available to the machine social network. The machine social network also includes an authentication process to link machines to the user.

Machines connect with other machines on an online social manner based on the social relationship of the user. Thus, a user subscribing to an online professional social media site may have 100 “friends” that are contacts and known to the user. The machines of the user may link or network with the allowed devices of these friends.

The term “social network” may encompass traditional social networking sites, such as FACEBOOK™, LINKEDIN™, TWITTER™, INSTAGRAM™ and the like. It also may include email groups or lists of the user, such as GOOGLE™ groups, YAHOO™ groups, corporate email groups, professional list servers, private email groups, organization email lists and the like. Forum memberships also may be included in the social network. Alumni groups or any user association with a club, body, organization and the like also may be included. In short, the “machine” social network includes machines or devices of any person connected to other people based on the term “social network” defined above.

Machines also may become socially connected as friendly machines based on similarities of the machines. For example, smartphones may connect that has the same model, type, version, brand and the like. Other smartphones may connect based on having the same software, operating system, applications, and the like. Smartphones also may connect that have the same specifications or configurations, such as the same chipset model. Cars may connect based on similarity of horsepower, model type, engine type and the like. Televisions may connect based on similarity of Screen size, Scanning frequency, HD support, 3D support, etc.

Alternatively, different categories of machines may socialize. For example, mobile phones may socialize with cars, and vice versa, within the social network. Televisions may communicate with mobile phones.

The “machine” social network may be private for a user, where only machines owned by a single user communicate to each other. Preferably, the machine may be a device, such as a smartphone, that includes applications (“apps”) stored on the device. The device also may include settings, an operating system and possible a carrier. A smartphone would use the carrier to make calls and exchange data over a network of the carrier. Examples of carriers include VERIZON™, AT&T™, SPRINT™ and T-MOBILE™. Similar devices may be tablets and electronic notebooks. The apps on the device usually are backed up, or stored, at a server or a host computer. Thus, if something happens to the smartphone, a user may retrieve the apps and settings from the storage.

A user may allow its machines to share all or limited information beyond its personal network. For example, a user may share its smartphone model universally in the social network but share applications installed in the smartphone with only trusted machines its social network. Other users of the disclosed embodiments can exchange information with the user on use, apps stored on the device and usage information pertaining to various parameters of the smartphone.

Once the machines are connected over the machine social network, then these machines may generate reports and recommendations for users based on the social circle of the machine. For example, these recommendations may include applications to install such as the most popular gaming application within the social network of the machine or most popular wireless carrier and their plans within the social network of machines or the most popular phone within the social network of machines.

Machines within the machine social network also can compare the machine's or its parts' performance within the machine social network. For example, a smartphone may compare battery performance data with other smartphone within the social network. Another example is recommending which gas station provides the best mileage based on the social circle of connected transportation machines.

Machines within the machine social network also may share specifications. For example, mobile phones and smartphones may share information about their specifications and capabilities, such as chipset details, battery details, screen display details, camera details, and the like. This information does not necessarily have to be personal information about the user of the machine, but is about the machine itself. Cars within the machine social network may share information about the engine, fuel economy, fuel tank capability, horsepower, repairs, and the like. Sharing machine specifications within social network will help humans make an informed decision about choice of their machines for upgrades and future purchases. Humans can ask for a report on popular machine specs in their “machine” social network to make an informed decision.

Machines and devices may share information about their service providers. For example a smartphone may share about its network carrier, peak achievable data rate, network coverage and the like. This feature may be especially important for users that desire to talk to friends having the same carrier, or do not want to exceed one's data plan. Using the machine social network, this information may be shared automatically. Cars or other vehicles may share information about their engine servicing vendors, tire vendors, gas stations, oil change providers and the like.

In a private device social network, machines and devices may help users in making timely informed decisions. For example, a connected refrigerator may remind a connected vehicle about the need for groceries. A connected appliance may alert a mobile phone, and the user, that service is needed, or a battery is low.

### BRIEF DESCRIPTION OF THE DRAWINGS

The accompanying drawings are included to provide further understanding of the invention and constitute a part of the specification. The drawings listed below illustrate embodiments of the invention and, together with the description, serve to explain the principles of the invention, as disclosed by the claims and their equivalents.

FIG. 1A illustrates a flowchart for implementing a device social network according to the disclosed embodiments.

FIG. 1B illustrates a flowchart for compiling information over a device social network according to the disclosed embodiments.

FIG. 2 illustrates machine socializing scenario within a device social network according to the disclosed embodiments.

FIG. 3 illustrates another device socializing scenario within a device social network according to the disclosed embodiments.

FIG. 4 illustrates another device socializing scenario within a device social network according to the disclosed embodiments.

FIG. 5 illustrates a block diagram of a smartphone and its associated information that may be made available for the disclosed device social network according the disclosed embodiments.

FIG. 6 illustrates the application front end processes for the smartphone according to the disclosed embodiments.

FIGS. 7A-C illustrate application back end processes of the smartphone according to the disclosed embodiments.

FIG. 8 illustrates phone discovery front end processes for the smartphone according to the disclosed embodiments.

FIGS. 9A-C illustrate phone discovery back end processes for the smartphone according to the disclosed embodiments.

FIG. 10 illustrates carrier discovery front end processes for the smartphone according to the disclosed embodiments.

FIG. 11A-C illustrate carrier back end processes for the smartphone according to the disclosed embodiments.

FIG. 12 depicts a block diagram of a smartphone according to the disclosed embodiments.

### DETAILED DESCRIPTION OF THE PREFERRED EMBODIMENTS

Aspects of the invention are disclosed in the accompanying description. Alternate embodiments of the present invention and their equivalents are devised without parting from the spirit or scope of the present invention. It should be noted that like elements disclosed below are indicated by like reference numbers in the drawings.

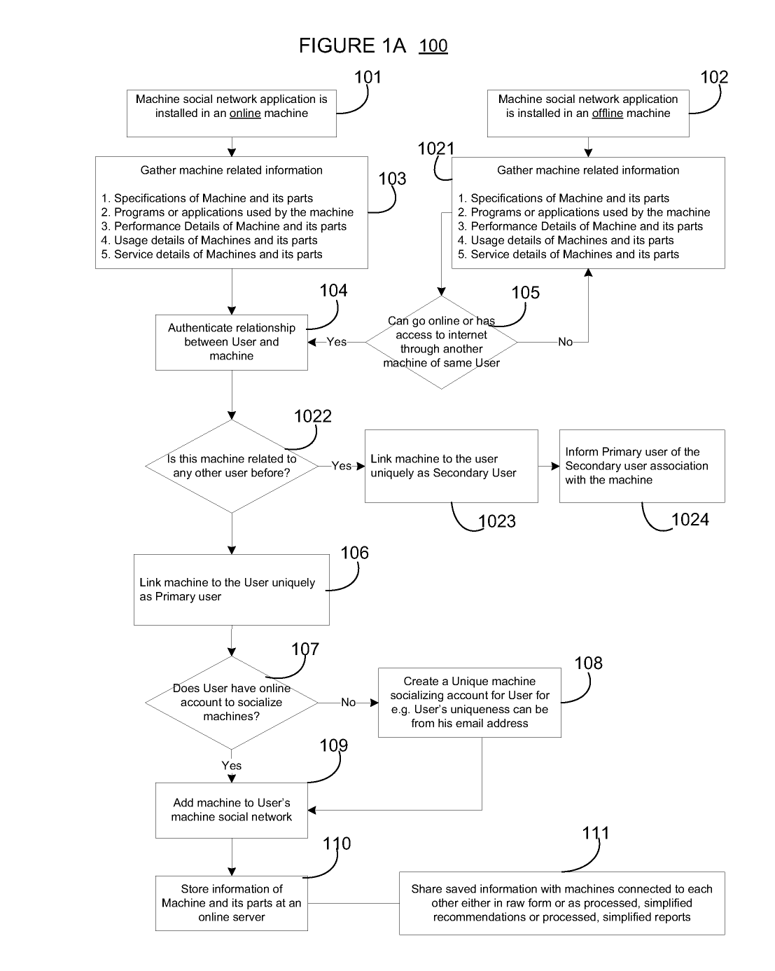

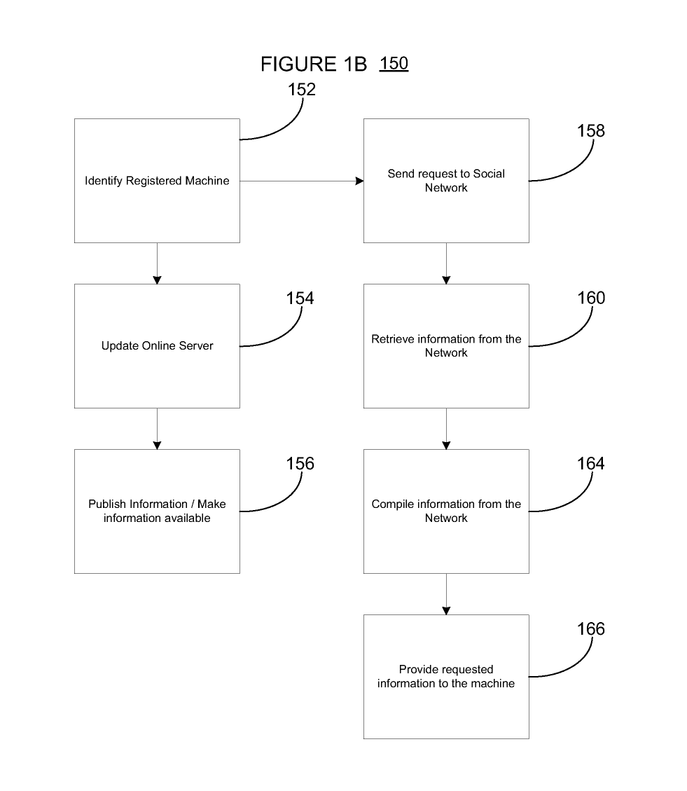

FIG. 1A depicts a flowchart 100 for implementing a machine social network according to the disclosed embodiments. The steps disclosed below may be implemented by a software application executed on a machine or device. These terms are used interchangeably below. The application socializes machines owned by users (humans) connected to each other either through a human relationship, or connected to each other through an online social networking service, such as FACEBOOK™, TWITTER™, LINKEDIN™, and the like. The social network relationships between users are used to establish a relationship between the machines.

A user may allow his devices to automatically socialize with a group of similar devices having corresponding hardware or software. For example, smartphones using the same software or application may be allowed to socialize with each other. The application associated with the disclosed embodiments may allow this socialization to occur.

Referring to FIG. 1, step 101 executes by installing the device social network application in an online device. As noted above, these machines or devices such as smartphones, tablets, laptops and the like are able to access online networks using a carrier, or a wireless connection. Step 103 executes by gathering device-related information for the machine or device. This information may include specifications of the device and its parts, programs or applications, performance details, usage details, service details, and the like for an online device.

Step 102 executes by installing the device social network application in an offline machine, such as an appliance or other device not able to independently access an online network. This step is applicable for a device when it is not able to connect to a network to access online resources, such as a server. This offline mode allows data gathering operations to occur and then the online operations occur when a connection is available. Step 1021 executes by gathering device-related information, such as specifications, programs or applications, performance details, usage details, service details and the like for an offline device.

After step 1021, flowchart 100 executes step 105 by determining whether the offline device can go online or has access to the Internet through another machine of the same user. Socially connected devices may directly connect to the Internet in step 101, or may use a wireless transfer technology to send information to the social network through an Internet connected device. For example, a car navigation system owned by a user may be allowed to share information within the social network. The car navigation system may not be connected online, but may use user's smartphone, which also is allowed to share information over the social network. Thus, at least one device of a user should be able to connect to the Internet.

If offline devices installed with machine social network application cannot reach the Internet as shown in conditional step 105, then flowchart 100 returns back to step 1021. If yes, then step 104 executes by authenticating the relationship between the user and the device.

A machine or device may be associated with multiple users once authenticated for e.g multiple family members may want to associate a family car with their account. Step 1022 verifies if the machine or device is associated with any user already.

Step 106 executes by linking the machine or device to the user as primary user if it is not associated by any other user identified at step 1022. The device is linked using a unique identifier, such as smartphone 1 plus username, where the username may be a unique email address. Thus, the device is linked uniquely to the user so that the user and the social network can differentiate between all registered devices of the user.

Step 1023 executes by linking the machine or device to the user as secondary user if it already has primary registered user association. The device is linked using a unique identifier, such as smartphone 1 plus username, where the username may be a unique email address. A device within the social network may identify itself with its genre or model type, and its human ownership, or which primary or secondary account it is registered to. A smartphone belonging to John may identify itself as smartphone.1.john, while John has his own unique tag, such as his email address.

Step 1024 informs the primary user of a new secondary user association to his registered machine or device. The users may exchange their primary or secondary status which may or may not bring account privilege with the associated machine or device. A primary user may abandon his primary association to the machine or device for e.g in case of selling of connected car already registered in machine social network to a new owner.

Step 107 executes by determining whether the user has online account to socialize devices. If no, then step 108 executes by creating a unique device socializing account for the user. The account corresponds to the user's uniqueness, such as using an email address. A user of a device will have a login account to manage which devices in his ownership will socialize after the disclosed application is installed on the device. The user also will manage which information from devices can be shared in the social network. The login account for the social network may be identical to a human socializing login account for well-known social networks. A user also may log into the application via an existing social network, such as using a FACEBOOK™, TWITTER™, LINKEDIN™, and the like.

A user may not own any devices or has not linked any of his devices to the social network. In these instances, the user may create an observer account to learn about devices and their details from users that consent to make public their device information.

If user has an online account to socialize machine or devices in step 107, then step 109 executes by adding the device to the user's social network. Step 110 executes by storing information about the device, settings, applicable software, applications, carrier/network information, chipset and the like, and its parts, and any other information, at an online server. Step 111 executes by sharing saved information with other devices connected to each other, either in raw form, or as processed, simplified recommendations, or processed, simplified reports. In other words, information may be exchanged with any filters or modification, or through scaled-down reports.

Users in the social circle of the device may generate on demand, or at regular intervals, reports about the devices in the social circle. Users also may compare performance of their device with their peers and may get recommendations from the social network, as disclosed above.

FIG. 1B depicts a flowchart 150 for compiling information over a social network according to the disclosed embodiments. Step 152 executes by identifying a registered device on the social network. The device may be registered online and has a unique identifier based on the user.

Step 154 executes by updating the online server with new or updated information from the disclosed application on the device at configured times. For example, the disclosed application may update the online server with a device's performance on an hourly, daily or weekly basis, as configured by the user. Further, the disclosed application may update the online server with device's specifications only once after the application is installed or whenever hardware or software of the device is upgraded. Step 156 executes by publishing this information, or making it available for reports and recommendations, over the social network. The information published or available for reports and recommendations may only be the information allowed by the user.

Step 158 executes by sending a request for information from the social network. The request may be for general information, such as data for all similar device types, or for specific information. Step 160 executes by retrieving information from the social network. The information may be stored on a server accessible over the Internet.

Step 164 executes by compiling information from the devices within the social network. The disclosed embodiments may mine the data stored in the online server. Step 166 executes by providing the requested information to the device using the online connection.

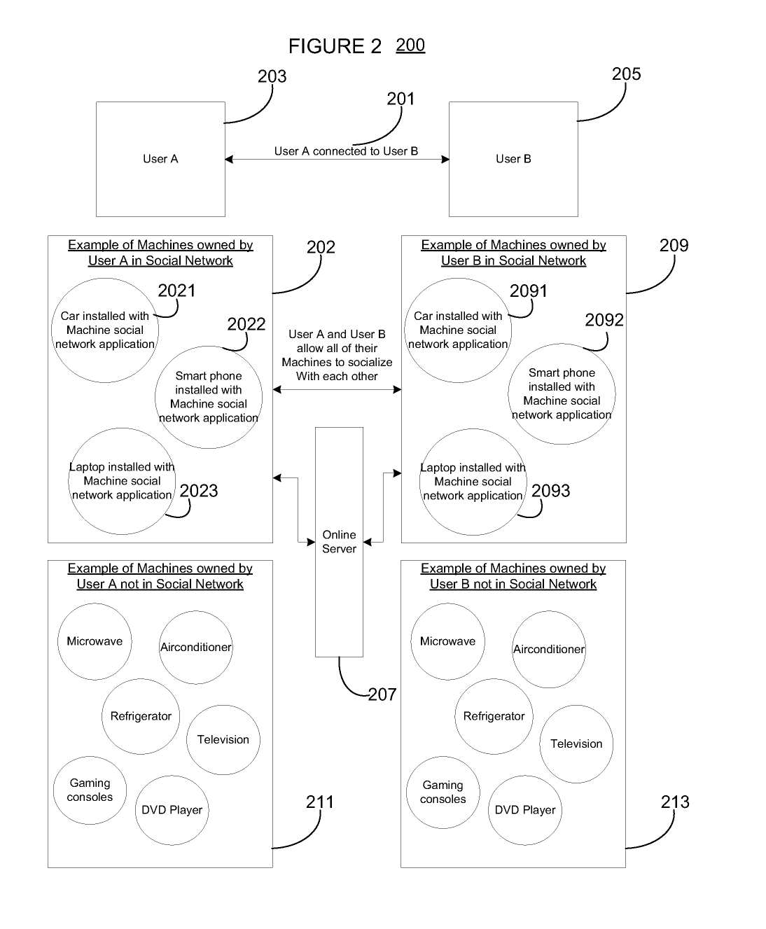

FIG. 2 depicts a device social network 200 according to the disclosed embodiments. Users 203 and 205 may own devices or machines that may be broken down into at least two groups. User 203 owns devices 202 that are in device social network 200, and owns devices 211 that are not in social network 200. User 205 owns devices 209 in social network 200, and devices 213 that are not in social network 200. Each device may be configured with a processor and other associated components, further disclosed below.

Devices 202 includes car 2021 installed with the device social network application, smartphone 2022 installed with the disclosed social network application and laptop 2023 installed with the disclosed social network application. Devices 211 may be appliances that are not installed with social network application.

Devices 209 of user 205 include car 2091, smartphone 2092 and laptop 2093. Devices 213 are not installed with the disclosed social network application. User 203 and user 205 enjoy a social network connection 201, which is made available to server 207, and based on their human connection they also allow all of their devices to socialize with each other. Server 207 also receives updates and information from devices 202 and 209.

The relationship between the devices in social network 200 may be cross-genre. For example, smartphone 2022 may socialize with car 2091 to exchange information. Both devices may upload information to server 207. User 203 may want to find which users within his social network that owns a car of a certain horsepower. Thus, devices 202 may socialize with car 2091. Another example may be that user 205 desires to find out what wireless carrier is popular in a new location, and receives such information from smartphone 2022 of user 203.

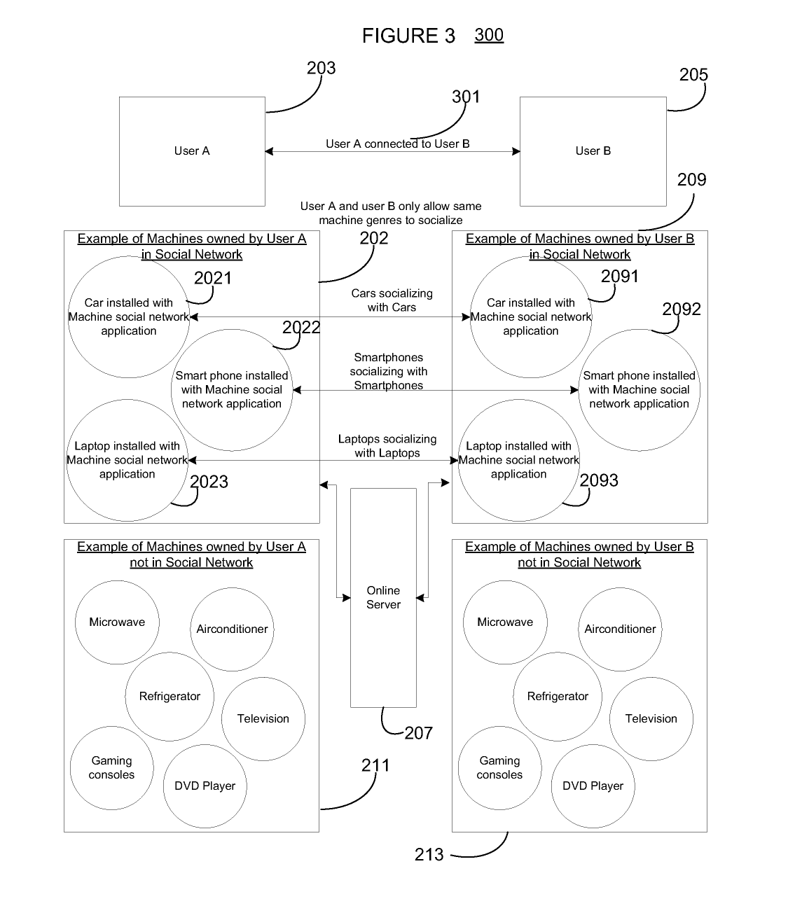

FIG. 3 depicts another scenario of a device social network 300 according to the disclosed embodiments. Device social network 300 resembles device social network 200 in that user 203 owns devices 202 and 211, and user 205 owns devices 209 and 213. User 203 and user 205 enjoy social network connection 301 that allows only like, or similar, devices to communicate. Thus, for example, car 2021 may access machine social network 300 to socialize, or exchange information, with car 2091. Specifically, the computers located within cars 2021 and 2091 exchange information.

Device social network 300 limits the amount of information, possibly for quicker response or privacy concerns. User 203 of smartphone 2022 may be interested in those applications that are installed on other smartphones of users within his circle, such as smartphone 2092. User 205 may own car 2091 and is interested in those users within her social network that own similar cars, such as car 2021.

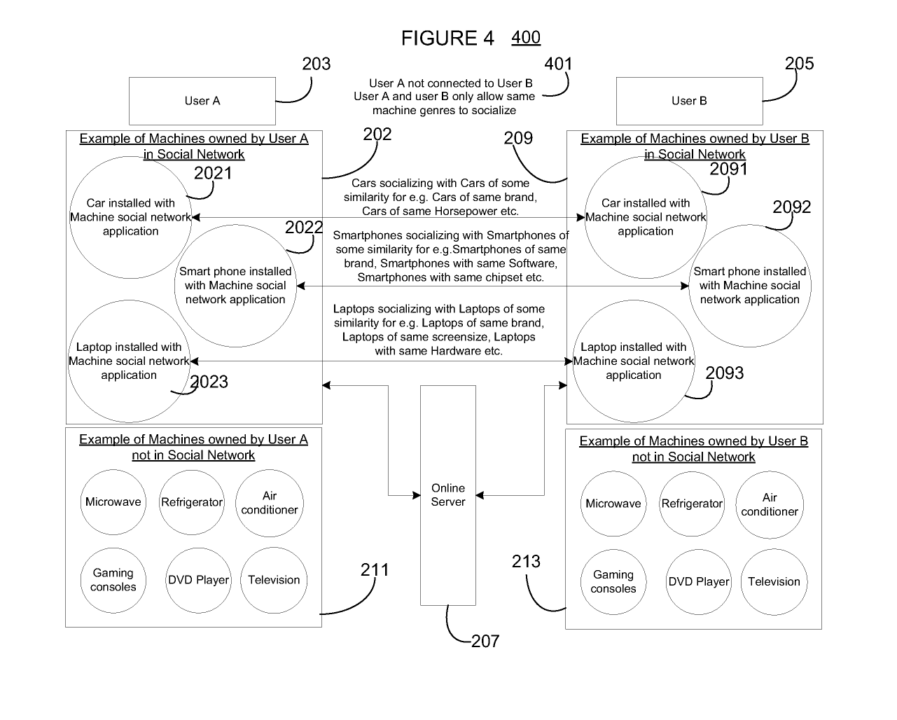

FIG. 4 depicts another scenario of a device social network 400 according to the disclosed embodiments. Device social network 400 differs from the others in that users 203 and 205 are not connected via a traditional social network. Thus, connection 401 refers to a relationship only between like machines or devices and allows similar devices to exchange information.

Devices 202 registered on device social network 400 searches for machines having the same genre, software, model, make, brand and the like, in order to establish a connection online. For example car 2021 may determine that car 2091 is the same make and model, and, therefore, exchanges service information. User 203 may wish to compare his car's performance against others having the same make and model.

A device social network differs from the traditional human social network in that devices would need to be programmed with the application to become active participants in the network. Without the application, a device may not access the information provided on the network. A social network of devices differs from a social network of humans as it would generate reports and recommendations for human users or may take pre authorized actions, which are more focused on improvement of quality of life of humans rather than information sharing or performance improvement of machines or devices.

Moreover, this information would need to be stored and shared electronically. A human would have to call their friend to request the information while the device may access the information online. This feature allows the device to access a vast array of data from a plurality of devices at once, as opposed to posting or asking each user individually. The social networking of devices can socialize billions of devices and machines instantly based on the user settings and analyze allowed information from user's devices and machines and share the results with humans.

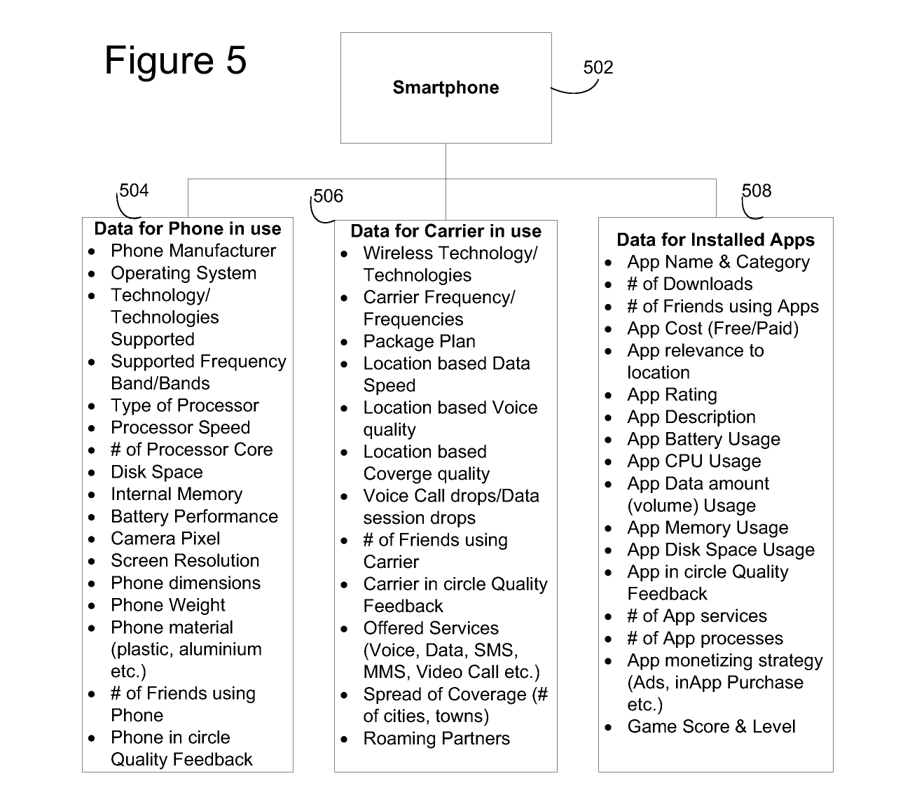

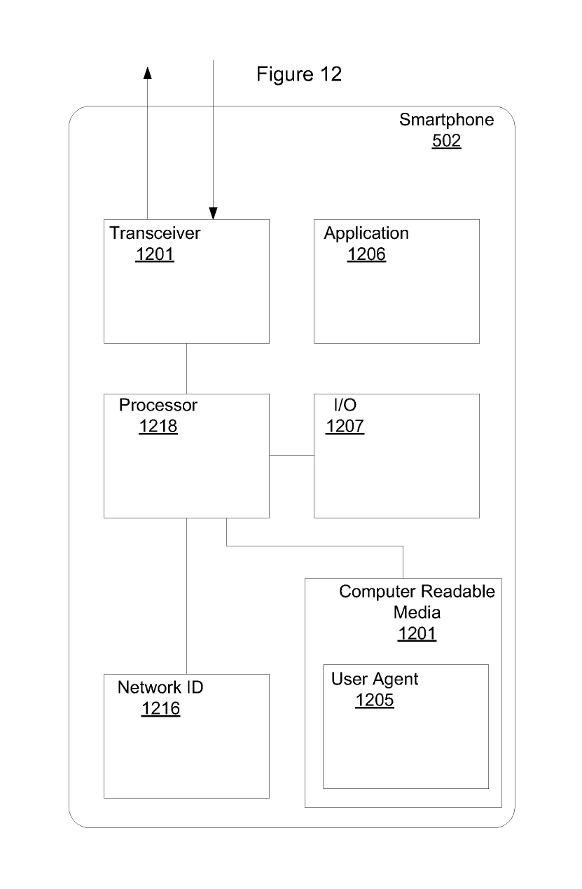

FIGS. 5-12 provide an example of the disclosed embodiments as it pertains to a smartphone configuration. The disclosed application is installed on the smartphone. Thus, FIG. 5 depicts a block diagram of the data sets associated with a smartphone 502 that may be made available for the disclosed device social network according the disclosed embodiments. Smartphone 502 may be a device that incorporates the process and functionality disclosed above. Smartphone 502 includes a computer/processor as well as circuitry to perform telephone operations, and this is disclosed in greater detail by FIG. 12.

Although a smartphone is disclosed below, other smart devices may be incorporated into the discussion below. Such smart devices include smart televisions, smart cars, smart watches, smart glasses, smart tablets, and the like.

The example of using smartphone 502 with the disclosed social network application may apply when a user switches from one version of a smartphone (i.e., a Galaxy S4™) to another (iPhone 5) or upgrades his Smartphone OS for e.g. from iOS 6 to iOS 7. The user of the new device may want to see which smartphone is most popular with his social network or how many of his friends have upgraded to a newer OS. He also may want to see what carrier/network his friends use. Using the disclosed social network application, he can share and receive detailed carrier information and statistics of his social network.

Another example may be sharing information regarding a game or application embedded in smartphone 502. The user may want to see what levels of a game and scores that others within his social network has achieved. The user of smartphone 502 may ping his friends to get feedback on the device experience.

Smartphone 502, through usage, may generate data that is stored or associated with the smartphone. Data includes data set 504 for the phone in use, data set 506 for the carrier in use, and data set 508 for installed applications. Other sets of data also may be available or generated by smartphone 502. Data sets 504, 506 and 508 may be of main interest to others within the user's social network and made available for review using the disclosed application.

Data set 504 relates to the data of smartphone 502 while in use. The data include the phone manufacturer, the operating system, the technology/technologies supported by smartphone 502, frequency bands supported, the type of processor used by smartphone 502, the processor speed, the number or serial designation of the processor core, the disk space or memory available on smartphone 502, internal memory, battery performance, camera pixel capabilities, screen resolution, phone dimensions (length, width, height), phone weight, phone composition materials (plastic, metal, etc.), the number of friends or users for smartphone 502, number of contacts, quality feedback and the like.

Data set 506 relates to the data of the carrier supported by smartphone 502. In order to place calls and access global networks, most users engage a carrier to support these functions. The data include wireless technology/technologies used by smartphone 502, carrier frequency, the package plan, location-based data speed, location-based voice quality, location-based coverage quality, call drops for voice and data session drops, number of friends using the carrier, the carrier ratings, quality feedback, offered services (voice, data, SMS, MMS, video calls, caller id, voicemail, etc.), spread of coverage within cities and towns, roaming partners and the like. Limits may be placed on the availability of this information by the carrier.

Data set 508 for installed applications, or “apps,” may refer to standalone software components that reside on smartphone 502. Many users download applications to their smartphones, and the numbers of applications can be several to dozens installed on a device. The data for the installed applications may be of great interest to users of the device social network.

Data set 508 includes the application name and category (game, tool, banking, etc.), number of downloads, numbers of friends using applications, application costs status which includes free, application relevance to location, application rating, application description, application battery usage, application CPU usage, application data amount (volume) usage, application memory usage, application disk space usage, application quality feedback, number of application background and foreground services, number of application background and foreground processes and any application monetizing strategies, game scores and levels and the likes.

The disclosed embodiments are enabled by an application downloaded to smartphone 502, which provides the interface and options to the user to perform operations. The application uses information provided by a social network environment and provide an experience to a user, which may be known as the “front end” of the application. These actions may be performed by the application upon instruction by the user. The application “back end” are those tasks performed by the application using the smartphone components and network connections.

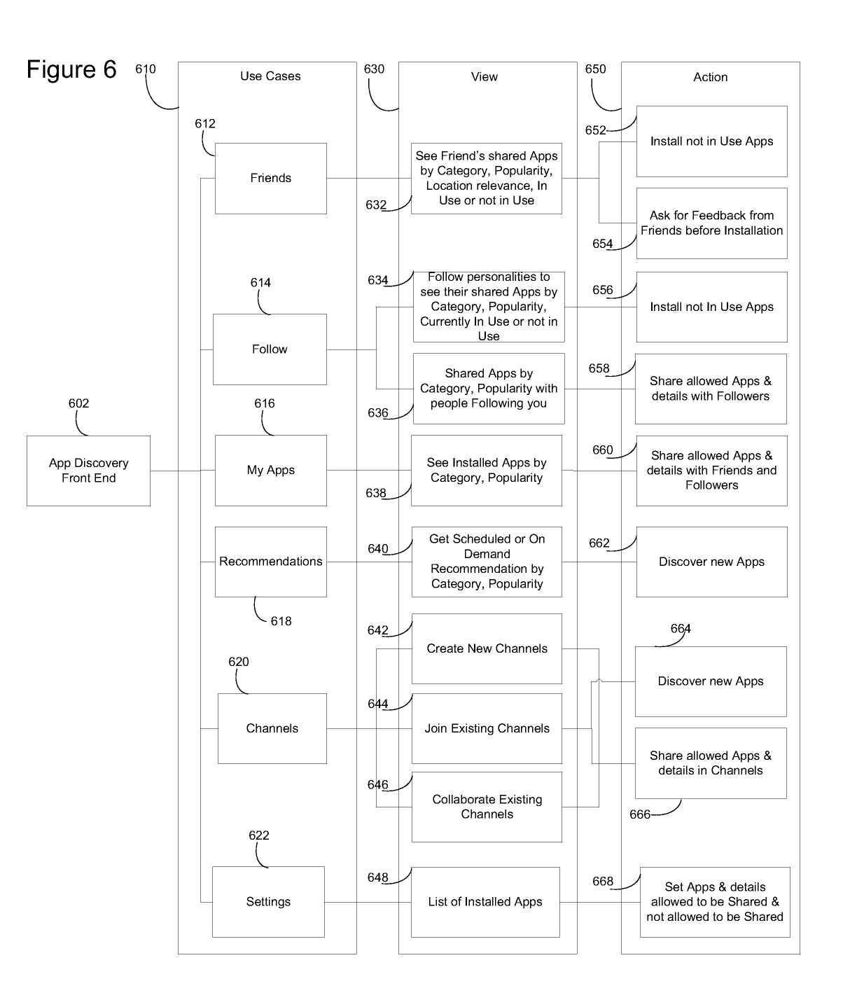

FIG. 6 depicts the application front end processes 602 for smartphone 502 according to the disclosed embodiments. Application “discovery” front end processes 602 are enabled by the disclosed application and include actions, as listed as use cases 610. Use cases 610 result in view actions 620. View actions 620 provide a description presented to the user of what the actions entail. View actions may be the results of the use case selected. Usage actions 650 refer to the action to be taken as a result of use cases 610.

The components of FIG. 6 will now be disclosed with regard to the appropriate use case and corresponding view and usage actions. Friends step 612 proceeds to step 632. This action allows the user to see friend's shared applications by category, popularity, location relevance, and/or be currently in use or not in use or other criteria. The application allows the user to rank and search for applications used or not used by friends using the disclosed embodiments. The application then may perform steps 652 and 654. Step 652 installs applications found in step 632 not currently on smartphone 502. Step 654 asks for feedback from friends before installing any applications seen in step 632.

Follow step 614 proceeds to steps 634 and 636. By following using the application on smartphone 502, the user may follow personalities to see their shared applications by category, popularity, location relevance or other criteria, and/or those applications in use or not in use in step 634. The user may follow celebrities, teachers, political figures and the like and see what applications those people use. Then, the user may download those applications. Thus, step 656 includes installing applications found in step 634 not currently on smartphone 502.

Follow step 614 also proceeds to step 636 for people who can follow you. The user may view and share applications by category, popularity, location relevance and the like of those people currently following the user. Thus, the user may have an additional source of recommended applications from those people that follow him besides being a source of recommendation for his followers. Step 658 then shares these applications with followers.

“My Apps” step 616 relates to the applications of the user already on smartphone 502, and results in step 638, which allows the user to see installed applications. These applications also may be sorted by popularity, category and the like. Step 660 resulting from this view action includes sharing these applications with friends and followers within the social network. The friends and followers can see the shared applications of smartphone 502.

Recommendations step 618 pertains to those applications received through recommendations of those people or devices on the social network or from the social network itself as a service to the user. Thus, recommendations step 618 results in step 640, which gets scheduled or on demand recommendations for applications. These recommendations may be based on category, popularity, location relevance and the like. Step 662 discovers new applications using these recommendations. The user may install these applications onto smartphone 502.

Channels step 620 pertains channels used by the application. Channels may be subject-related applications. For example, the user may have interests in golf, and therefore, subscribes to channels pertaining to golf. The user also may create a channel. The user may select step 642 to create a new channel. Step 646 collaborates existing channels. These view actions lead to step 666 to share applications in these channels. The user may install these applications onto smartphone 502. Step 644 permits the user to join existing channels, which leads to usage action that discovers new applications based on these channels in step 664.

FIG. 6 has the settings use case in step 622 which connects to step 648 where user can see list of installed apps in step 648 leading to step 670. Step 670 sets applications to be shared or not shared. One may not want every application on smartphone 502 to be shared within the device social network. For example, banking and financial applications should not be shared. Games, on the other hand, may be shared pretty freely. Thus, the user may use these actions to determine those applications that will remain secret or unavailable to the device social network. Using the smart television example, certain channels or services on the television should remain private and not shared with others.

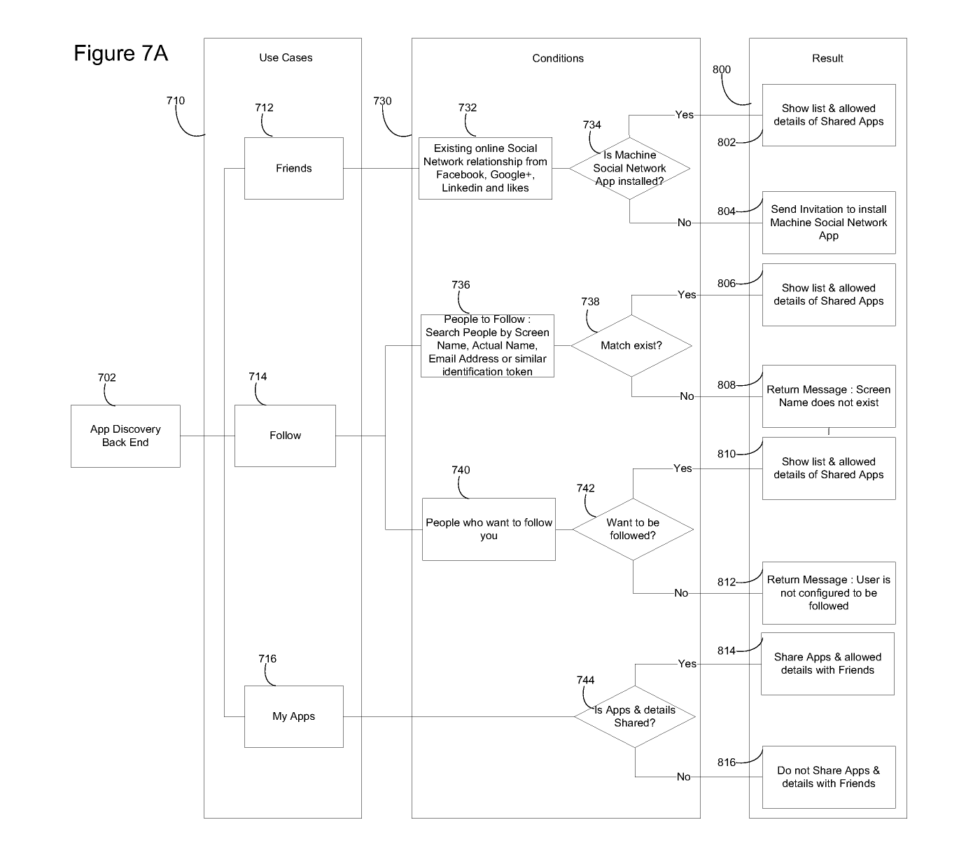

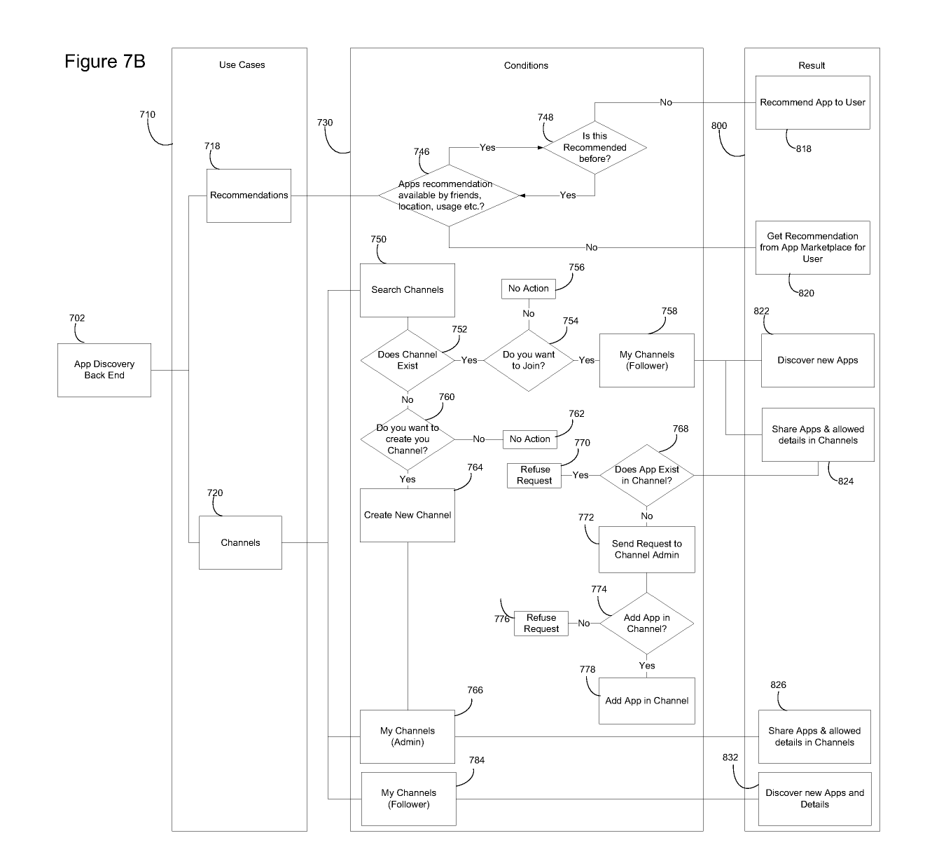

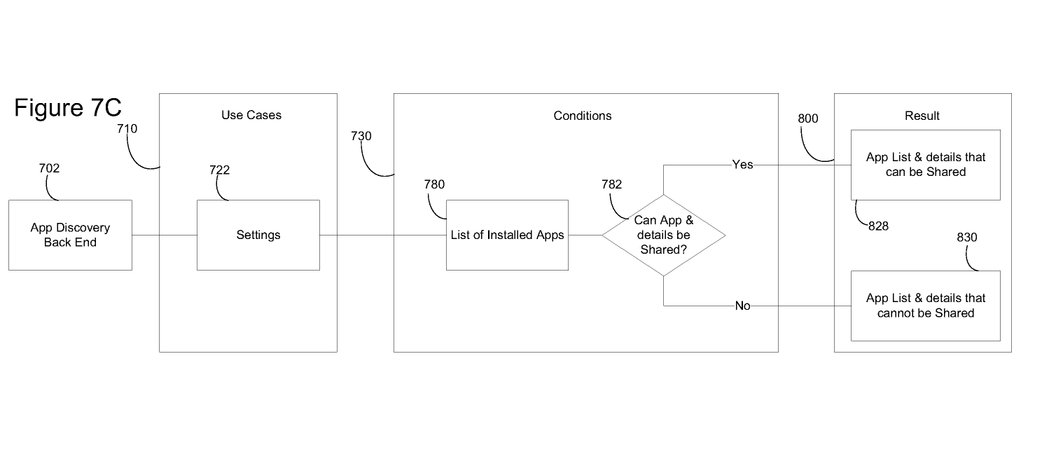

FIGS. 7A-C depicts application back end processes 702 of smartphone 502 according to the disclosed embodiments. As noted above, the back end may refer to the operations executed by the application on smartphone 502 to perform the actions requested on the front end of application. It may reflect the logic and algorithms used by the application to provide data and results to the user on installed applications on smartphone 502.

FIGS. 7A-C show use cases 710, conditions 730 and results 800. Use cases 710 includes friends step 712, follow step 714, “My Apps” step 716, recommendations step 718, channels step 720, and settings step 722, which minor most of use cases 610 in FIG. 6. Conditions 730 relate to decisions that are made before providing results 800. The appropriate condition and result will be disclosed as it relates to a particular use case.

Friends step 712, when selected, leads to step 732. Step 732 executes by determining an existing online social network relationship from a social media environment, such as FACEBOOK™, GOOGLE+™, LINKEDIN™, and the like. Step 724 executes by determining if the disclosed device social network application is installed. If step 734 is yes, then step 802 executes by showing a list of shared applications from the social network relationship. If step 734 is no, then step 804 executes by sending an invitation to the social network relationship to install the disclosed device social network application.

Follow step 714, when selected, leads to steps 736 and 740. Step 736 determines people to follow. People may be searched by screen name, user identification, actual name, email address or other similar identification token. Step 738 executes by determining whether a match exists. If step 738 is yes, then step 806 executes by showing a list of shared applications. If step 738 is no, then step 808 returns a message that the search target, such as the screen name, does not exist. Thus, this flow of steps allows the user to search for people of interest and view their shared applications if within the device social network.

Follow step 714 also leads to step 740. Step 740 executes by determining people who want to follow the user. Step 742 executes by determining whether the user wants to be followed. If step 742 is yes, then step 810 shows a list of shared applications. If step 742 is no, then step 812 returns a message that the user is not configured to be followed. Thus, the user may let others know that he does not want to be followed.

“My Apps” step 716 leads to step 744, which determines whether the application is shared. If step 744 is yes, then step 814 shares the application(s) with friends within the device social network. If step 744 is no, then step 816 does not share the application(s) with friends.

Recommendations step 718 leads to step 746. Step 746 executes by determining whether any application in a requested category is used by friends or has location relevance within the device social network or similar criteria to be used for recommendation. Location relevance may not be limited by friends, but looks to what is popular within that location. For example, the step may look to see what is popular within a city, such as Hong Kong, and makes this information available to the user. The disclosed embodiments can also search or look to see what is popular by usage. For example, usage may refer to downloads, network usage, minutes spent on the application(s), data downloaded using the application, and the like.

If step 746 is yes, then step 748 executes by determining whether this application was recommended before. If step 748 is no, then step 818 recommends the application to the user. If step 748 is yes, then the process goes back to step 746. If step 746 is no, then step 820 gets recommendation from application marketplace for the user.

Channels step 720 leads step 750. Step 750 searches channels of applications. Step 752 executes by determining whether the channel exists. If yes, then step 754 executes by determining whether the user of smartphone 502 wants to join the channel. If step 754 is no, then step 756 takes no action. Step 758 executes by joining the channel and adding the channel to the user's channels. The user preferably will be a follower of the channel.

Step 822 discovers new applications on the channel. Step 824 shares applications and allowed details in the channel from the user. In other words, when the user joins a channel of interest, then the user may download or share applications. The channel may be fantasy football with various applications for getting football scores, lists, team pages, and the like. The user joins the channel and then downloads those applications of interest, as well as sharing the user's fantasy football applications.

The process flows to step 768, which executes by determining whether an application that a user wants to share exists in the channel already. If yes, then step 770 takes no action. If step 768 is no, then step 772 sends a request to the channel administrator. Step 774 determines whether the application can be added to the channel. If no, then step 776 refuses the request to add the application. If step 774 is yes, then step 778 adds the application to the channel.

Referring back to step 752, if it is no, then step 760 executes by determining whether the user wants to create a new channel. If no, then step 762 takes no action. If step 760 is yes, then step 764 creates the new channel. Step 766 confers Channel Admin rights to the user who has created the channel. Step 826 shares the new channel and associated applications along with any details to the device social network. Further, the user may flow directly from channels step 720 to step 784 to view Channels that he has joined as a follower. Using this direct method to step 784, step 832 discovers new applications using these channels. In other words, other users associated with the channels may make their applications available, so that the user can discover them along with everyone else.

Settings step 722, when selected, leads to step 780. Step 782 executes by providing a list of installed applications. Step 782 executes by determining whether an application and its details may be shared. If step 782 is yes, then step 828 provides an application list and details that can be shared. If step 782 is no, then 830 provides an application list and details that cannot be shared.

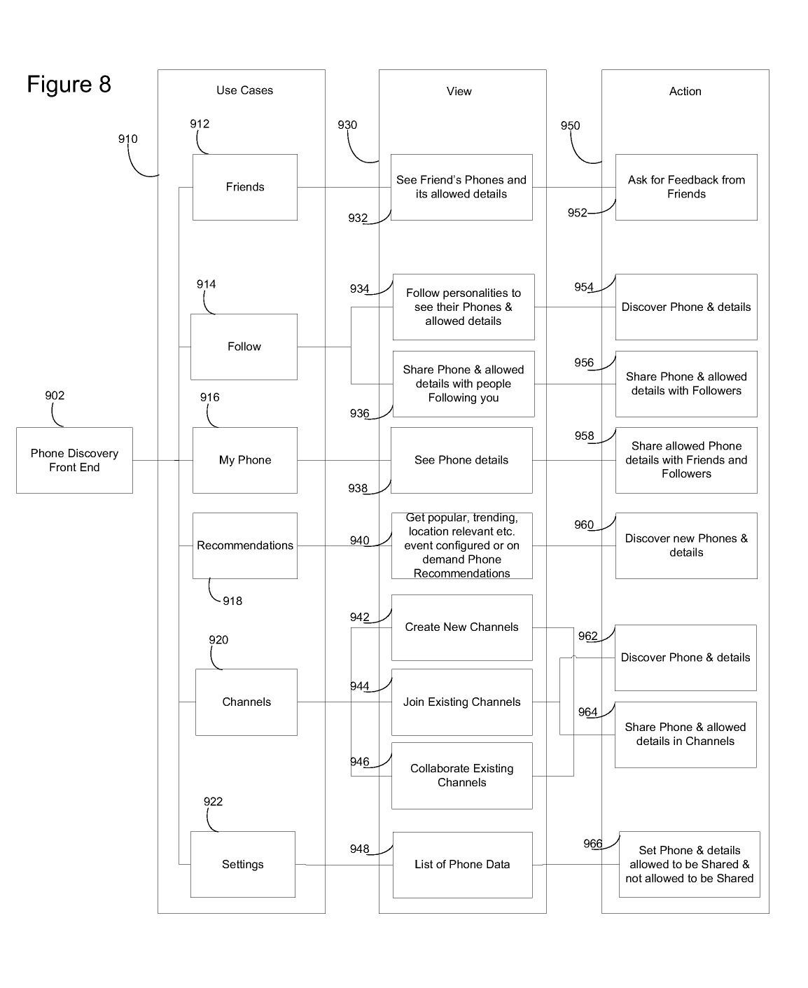

FIG. 8 depicts phone discovery front end processes 902 for smartphone 502 according to the disclosed embodiments. FIG. 8 shows use cases 910, view actions 930 and actions 950. While FIGS. 6 and 7A-C related to the use of applications within the device social network, phone processes relate to data set 504 for the phone in use.

Friends step 912, when selected, leads to step 932. Step 932 sees friends' phones and their allowed details. Step 952 executes by asking for feedback on the phone from friends within the device social network. Using the disclosed application, the user may view phone data details from other friends within the device social network.

Follow step 914, when selected, executes by flowing to steps 934 and 936. Step 934 follows personalities to see their phones and allowed details in step 954. The user may wish to follow their favorite athletes, teachers, business leaders, etc., and determine how they best use their phones. Step 936 shares phone data 504 and allowed details with followers of the user in step 956.

“My Phone” step 916 leads to step 938. Step 938 provides phone details to the user to see. Step 958 shares allowed phone details with friends and Followers within the device social network.

Recommendations step 918 leads to step 940. Step 940 gets popular, or trending, or location relevant, scheduled, or event configured or on demand phone recommendations. These recommendations may be provided by friends within the device social network, or from the social network server, or from groups, lists, and the like. Step 960 discovers new phones and details based on the recommendations.

Channels step 920 leads to three steps. Step 942 creates new channels. Step 944 joins existing channels. Step 946 collaborates existing channels. These channels may be similar to the channels disclosed above for applications. Steps 942 and 946 lead to step 964, which shares phone data 504 and allowed details in the channels. Step 944 to join existing channels leads to step 962. Step 962 discovers the phone and details in the existing channels. Step 944 can also lead to step 964 to share phone and details in the existing channels.

Settings step 922 leads to step 948 where user can view phone details. Step 966 executes by setting the phone and details data allowed to be shared or not shared. The user may configure the information allowed to be shared over the device social network.

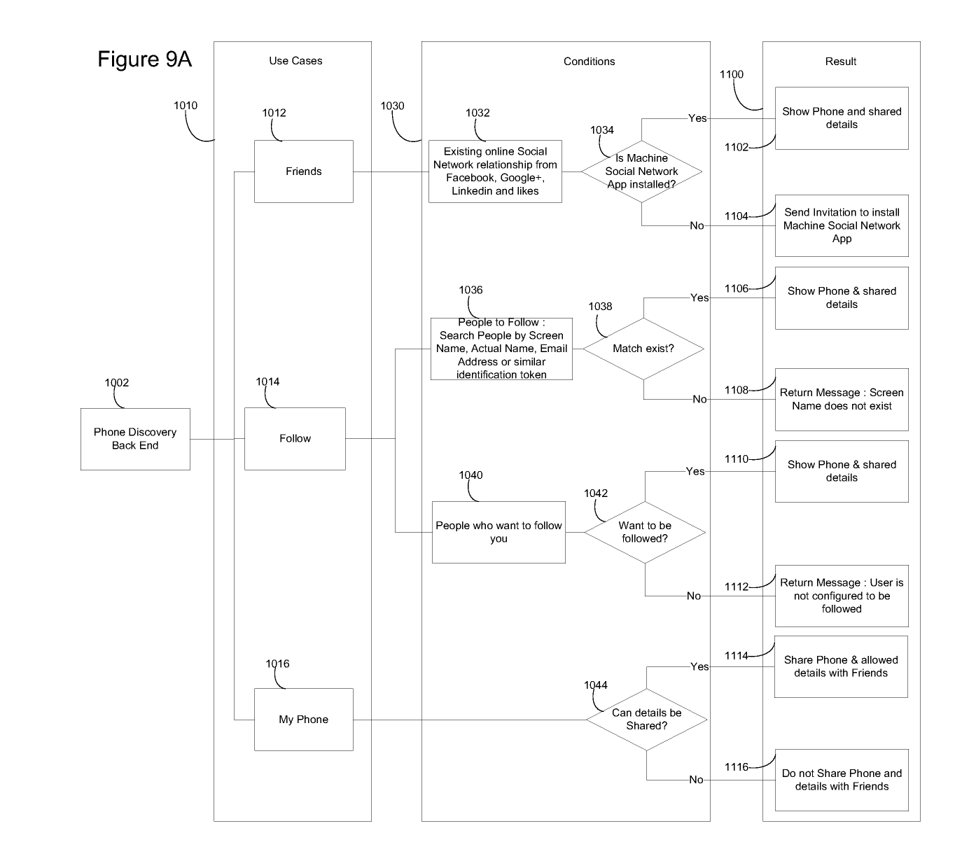

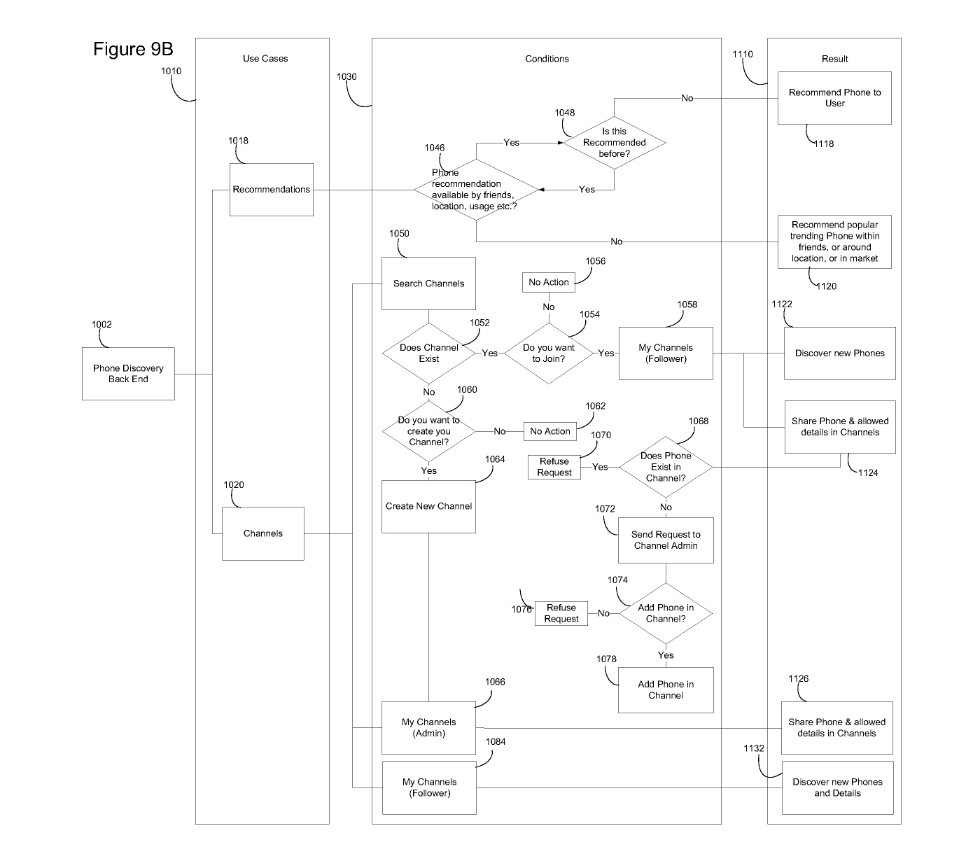

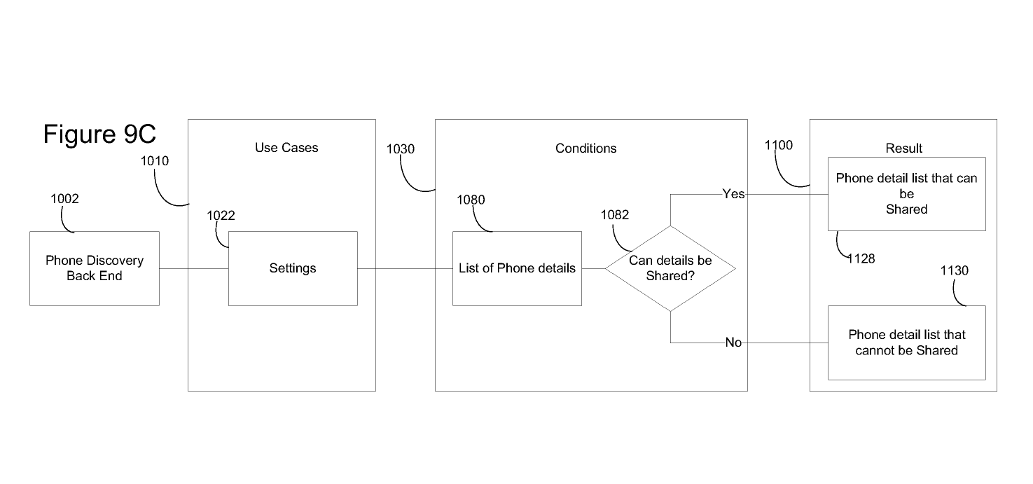

FIGS. 9A-C depict phone discovery back end processes 1002 for smartphone 502 according to the disclosed embodiments. As noted above, the phone back end processes may refer to the operations executed by the application on smartphone 502 to perform the actions requested on the front end of the application. It may reflect the logic and algorithms used by the application to provide data and results to the user about the phone information stored on or applicable to smartphone 502.

FIGS. 9A-C show use cases 1010, conditions 1030 and results 1100. Use cases 1010 includes friends step 1012, follow step 1014, “My Phone” step 1016, recommendations step 1018, channels step 1020, and settings step 1022, which minor most of use cases 910 in FIG. 9. Conditions 1030 relate to decisions that are made before providing results 1100. The appropriate condition and result will be disclosed as it relates to a particular use case.

Friends step 1012, when selected, leads to step 1032. Step 1032 executes by determining an existing online social network relationship from a social media environment, such as FACEBOOK™, GOOGLE+™, LINKEDIN™, and the like. Step 1034 executes by determining if the disclosed device social network application is installed. If step 1034 is yes, then step 1102 executes by showing the phone information and shared details from the social network relationship. If step 1034 is no, then step 1104 executes by sending an invitation to the social network relationship to install the disclosed device social network application.

Follow step 1014, when selected, leads to steps 1036 and 1040. Step 1036 determines people to follow. People may be searched by screen name, user identification, actual name, email address or other similar identification token. Step 1038 executes by determining whether a match exists. If step 1038 is yes, then step 1106 executes by showing the phone data of the contact and shared details. If step 1038 is no, then step 1108 returns a message that the search target, such as the screen name, does not exist. Thus, this flow of steps allows the user to search for people of interest and view their shared phone information if within the device social network.

Follow step 1014 also leads to step 1040. Step 1040 executes by determining people who want to follow the user. Step 1042 executes by determining whether the user wants to be followed. If step 1042 is yes, then step 1110 shows the phone data set and details. If step 1042 is no, then step 1112 returns a message that the user is not configured to be followed. Thus, the user may let others know that he does not want to be followed.

“My Phone” step 1016 leads to step 1044, which determines whether the details about the phone can be shared. If step 1044 is yes, then step 1114 shares the phone data set and details with friends within the device social network. If step 1044 is no, then step 1116 does not share the phone data set or details with friends.

Recommendations step 1018, when selected, leads to step 1046. Step 1046 may execute by determining whether popular phones in friends circle of the user or around user location are better in details than current phone within the device social network or similar recommendation criterias. For example, the user can search or view recommendations based on what the friends within the device social network provide, or other criteria. The criteria include location of the user so that the user can review popular phones based on his location or possibly a location of interest. Should the user desire to move from an urban location to a rural one, then he would want to see what phones are preferred in the rural location. The user also may want to look to usage for recommendations, such as how many people use the various types of phones, minutes used on the phones, data downloaded to the phones, average data throughput while in use and the like.

If step 1046 is yes, then step 1048 executes by determining whether this phone was recommended before. If step 1048 is no, then step 1118 recommends the phone to the user. If step 1048 is yes, then the process goes back to step 1046. If step 1046 is no, then step 980 gets a recommendation on a popular trending phone within friends, or around the user location, or based on market and likes.

Channels step 1020, when selected, leads to steps 1050 and 1066. Step 1050 searches channels. Step 1052 executes by determining whether the channel exists. If yes, then step 1054 executes by determining whether the user of smartphone 502 wants to join the channel. If step 1054 is no, then step 1056 takes no action. If step 1054 is yes, then step 1058 executes by joining the channel and adding the channel to the user's channels. The user preferably will be a follower of the channel.

Step 1122 executes by discovering new phones in the new channel. Step 1124 executes by sharing the user's phone data set and allowed details to the channel. The process then flows to step 1068, which determines whether the user's phone or details exists in the channel. If yes, then step 1070 refuses the request to share. If step 1068 is no, then step 1072 sending a request to the channel administrator. Step 1074 executes by determining whether to add the phone and details to the channel. If no, then step 1076 refuses the request. If step 1074 is yes, then step 1078 adds the phone and details to the channel.

Step 1066 also follows the selection of channels step 1020. Step 1066 relates to the administration of user created channels. Step 1066 confers channel administrator rights to the user who has created the channel. Step 1126 shares the new channel and associated phones along with any details to the device social network. Further, the user may flow directly from channels step 1020 to step 1084 to view channels that he has joined as a follower. Using this direct method to step 1084, step 1132 discovers new phones using these channels. In other words, other users associated with the channels may make their phones and details available, so that the user can discover these phones along with everyone else.

Settings step 1022, when selected, leads to step 1080. Step 1080 executes by providing a list of phone details for smartphone 502. Step 1082 executes by determining whether a phone and its details may be shared. If step 1082 is yes, then step 1128 provides a phone detail list that can be shared. If step 1082 is no, then 1130 provides a phone detail list that cannot be shared.

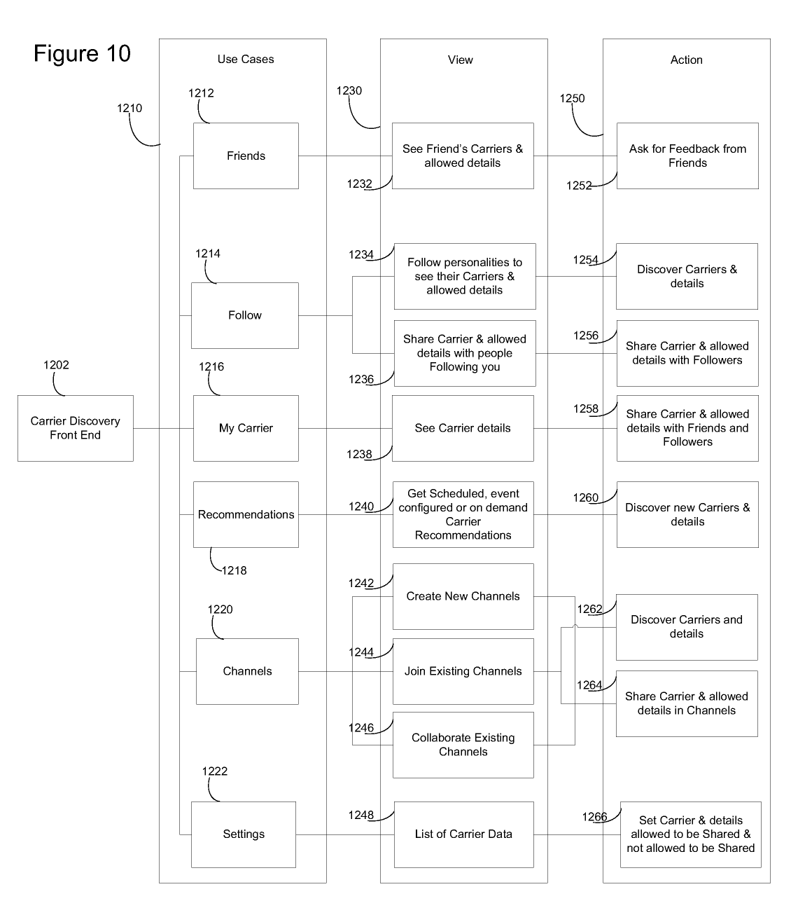

FIG. 10 depicts carrier discovery front end processes 1202 for smartphone 502 according to the disclosed embodiments. FIG. 10 shows use cases 1210, view actions 1230 and actions 1250. While FIGS. 6 and 7A-C related to the use of applications within the device social network, FIGS. 8 and 9A-C related to the use of phone within the device social network, carrier processes relate to data set 506 for the carrier in use.

Friends step 1212, when selected, leads to step 1232. Step 1232 sees friends' carriers and their allowed details. Step 1252 executes by asking for feedback on the carrier service from friends within the device social network. Using the disclosed application, the user may view carrier data details from other friends within the device social network.

Follow step 1214, when selected, executes by flowing to steps 1234 and 1236. Step 1234 follows personalities to see their carriers and allowed details. The user may wish to follow their favorite athletes, teachers, business leaders, etc., and determine how they best use carriers of network services. Step 1236 shares carrier data 506 and allowed details with followers of the user.

“My Carrier” step 1216, when selected, leads to step 1238. Step 1238 provides carrier details to the user to see. Step 1258 shares allowed carrier details with friends and followers within the device social network.

Recommendations step 1218 leads to step 1240. Step 1240 gets scheduled, event configured or on demand carrier recommendations. These recommendations may be provided by friends within the device social network, or from device social network server, or based on location relevance, or from groups, lists, and the like. Step 1256 discovers new carriers and details based on the recommendations.

Channels step 1220 leads to three steps. Step 1242 creates new channels. Step 1244 joins existing channels. Step 1246 collaborates existing channels. These channels may be similar to the channels disclosed above for applications and phones. Steps 1242 and 1246 lead to step 1264, which shares carrier data 506 and allowed details in the channels. Step 1244 leads to step 1262 and step 1264. Step 1262 discovers the applicable carrier and details in the existing channels. A user joining an existing channel in step 1244 may also share his carrier details data 506 in step 1264.

Settings step 1222 leads to step 1248 to view list of carrier data. Step 1266 executes by setting the carrier and details data allowed to be shared or not shared. The user may configure the information allowed to be shared over the device social network.

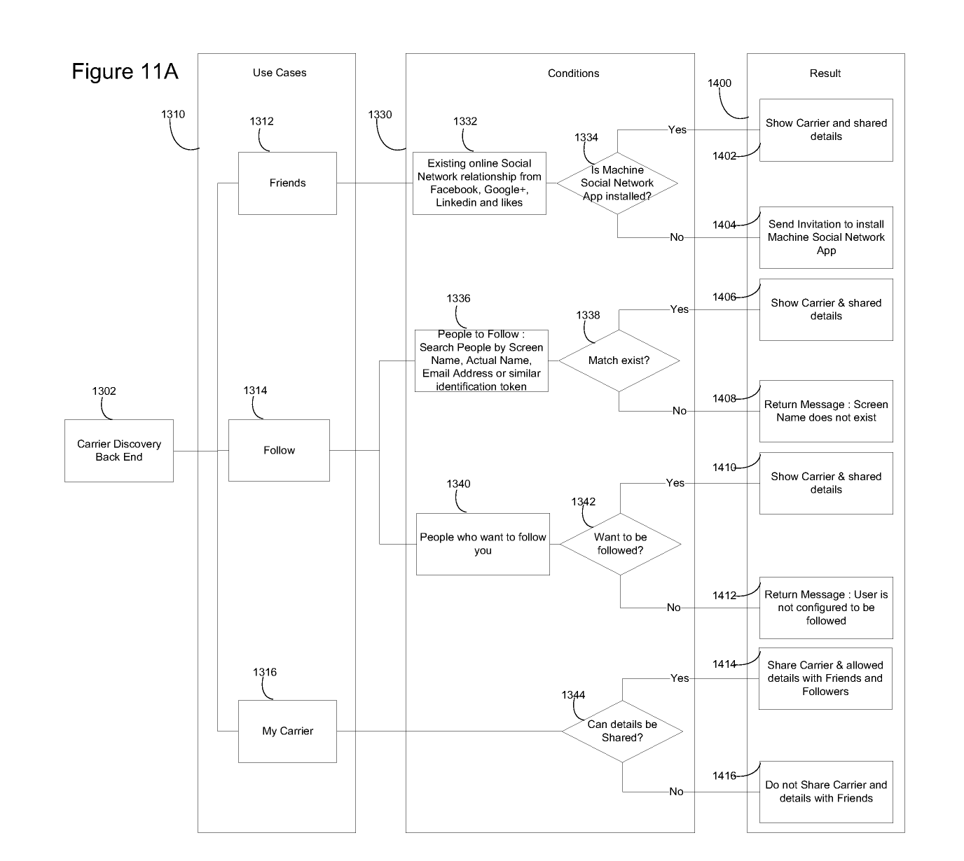

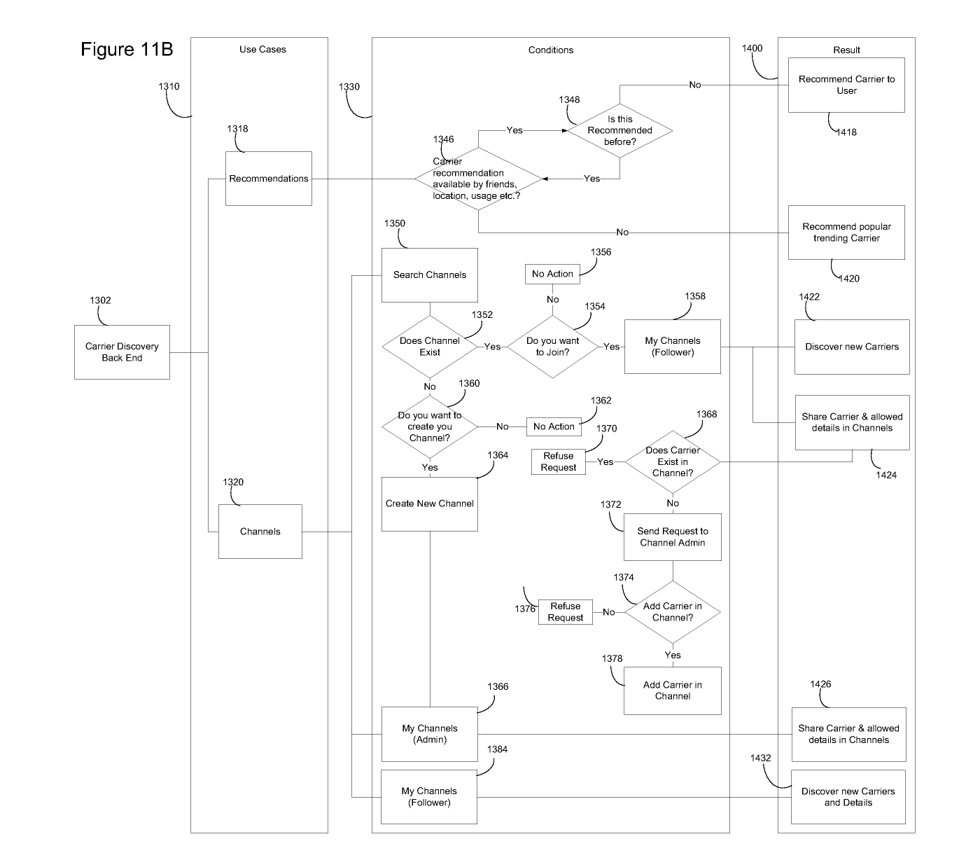

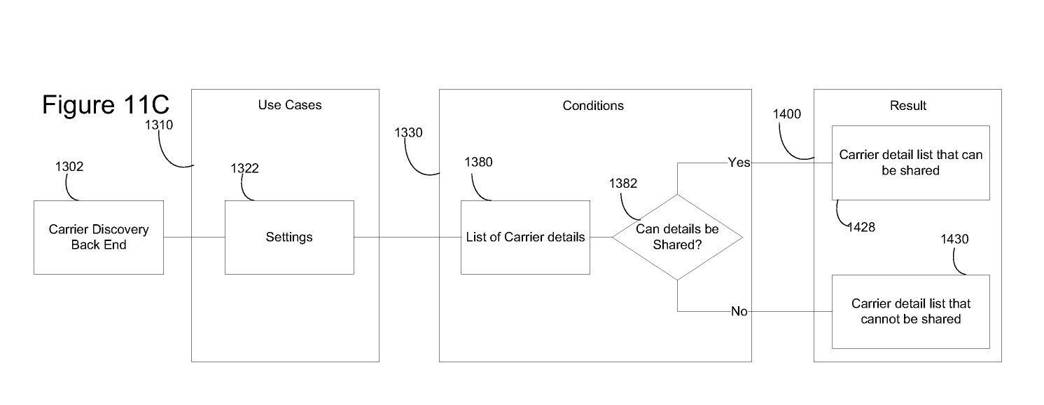

FIGS. 11A-C depict carrier discovery back end processes 1302 for smartphone 502 according to the disclosed embodiments. As noted above, the carrier back end processes may refer to the operations executed by the application on smartphone 502 to perform the actions requested on the front end of the application. It may reflect the logic and algorithms used by the application to provide data and results to the user about the carrier information within data set 506 stored on or applicable to smartphone 502.

FIGS. 11A-C show use cases 1310, conditions 1330 and results 1400. Use cases 1310 includes friends step 1312, follow step 1314, “My Carrier” step 1316, recommendations step 1318, channels step 1320, and settings step 1322, which minor most of use cases 1210 in FIG. 10. Conditions 1330 relate to decisions that are made before providing results 1400. The appropriate condition and result will be disclosed as it relates to a particular use case.

Friends step 1312, when selected, leads to step 1332. Step 1332 executes by determining an existing online social network relationship from a social media environment, such as FACEBOOK™, GOOGLE+™, LINKEDIN™, and the like. Step 1334 executes by determining if the disclosed device social network application is installed. If step 1334 is yes, then step 1402 executes by showing the carrier information and shared details from the device social network relationship. If step 1334 is no, then step 1404 executes by sending an invitation to the social network relationship to install the disclosed device social network application.

Follow step 1314, when selected, leads to steps 1336 and 1340. Step 1336 determines people to follow. People may be searched by screen name, user identification, actual name, email address or other similar identification token. Step 1338 executes by determining whether a match exists. If step 1338 is yes, then step 1406 executes by showing the carrier information of the contact and shared details. If step 1338 is no, then step 1408 returns a message that the search target, such as the screen name, does not exist. Thus, this flow of steps allows the user to search for people of interest and view their shared carrier information if within the device social network.

Follow step 1314 also leads to step 1340. Step 1340 executes by determining people who want to follow the user. Step 1342 executes by determining whether the user wants to be followed. If step 1342 is yes, then step 1410 shows the carrier data set 506 and applicable details. If step 1342 is no, then step 1412 returns a message that the user is not configured to be followed. Thus, the user may let others know that he does not want to be followed.

“My Carrier” step 1316 leads to step 1344, which determines whether the details about the carrier can be shared. If step 1344 is yes, then step 1414 shares the carrier data set and details with friends within the device social network. If step 1344 is no, then step 1416 does not share the carrier data set or details with friends.

Recommendations step 1318, when selected, leads to step 1346. Step 1346 executes by determining whether a popular carrier of services is in the social circle or around the user location that is better in details than the current carrier or similar criteria of recommendations. For example, the user can search or view recommendations based on what the friends within the device social network provide, or other criteria. The criteria may include location of the user so that the user can review popular carriers based on his location or possibly a location of interest. Should the user desire to move from an urban location to a rural one, then he would want to see what carriers are preferred in the rural location. This feature may be especially in important when making international relocations. The user also may want to look to usage for recommendations, such as how many people are signed up for different carriers, the number of calls handled by each carrier, the number of dropped calls by carrier, data downloaded by carrier, average data speed per carrier, and the like.

If step 1346 is yes, then step 1348 executes by determining whether the carrier was recommended before. If step 1348 is no, then step 1418 recommends the carrier to the user. If step 1348 is yes, then the process goes back to step 1346. If step 1346 is no, then step 1420 gets a recommendation on a popular trending carrier service.

Channels step 1320, when selected, leads to steps 1350 and 1366. Step 1350 searches channels. Step 1352 executes by determining whether the channel exists. If yes, then step 1354 executes by determining whether the user of smartphone 502 wants to join the channel. If step 1352 is no, then step 1356 takes no action. If step 1352 is yes, then step 1358 executes by joining the channel and adding the channel to the user's channels. The user preferably will be a follower of the channel.

Step 1422 executes by discovering new carriers in the new channel. Step 1424 executes by sharing the user's carrier data set and allowed details to the channel. The process then flows to step 1368, which determines whether the user's carrier and details exists in the channel. If yes, then step 1370 refuses the request to share. If step 1368 is no, then step 1372 sending a request to the channel administrator. Step 1374 executes by determining whether to add the carrier and details to the channel. If no, then step 1376 refuses the request. If step 1374 is yes, then step 1378 adds the carrier and details to the channel.

Step 1320 also follows the selection of channels step 1366. Step 1366 relates to the administration of user created channels. Step 1366 confers channel administrator rights to the user who has created the channel. Step 1426 shares the new channel and associated carriers along with any details to the device social network. Further, the user may flow directly from channels step 1320 to step 1384 to view channels that he has joined as a follower. Using this direct method to step 1384, step 1432 discovers new carriers using these channels. In other words, other users associated with the channels may make their carriers and details available, so that the user can discover the carriers along with everyone else.

Settings step 1322, when selected, leads to step 1380. Step 1380 executes by providing a list of carrier details for smartphone 502. Step 1382 executes by determining whether a carrier service and its details may be shared. If step 1382 is yes, then step 1428 provides a carrier detail list that can be shared. If step 1382 is no, then 1430 provides a carrier detail list that cannot be shared.

FIG. 12 depicts a block diagram of smartphone 502 according to the disclosed embodiments. Selected components of smartphone 502 are shown that enable the device to run device social network application 1206. Smartphone 502 includes transceiver 1201 for communicating with a cellular, wireless, ad-hoc or local area network. Using transceiver 1201, smartphone 502 may receive data from other devices located on the network. Smartphone 502 also may access databases and other components to enable the execution of the disclosed application 1206.

Smartphone 502 also includes computer readable media 1201 that may be random access memory, (RAM), read only memory (ROM), a hard drive, a memory card, a flash drive, and the like. User agent 1205 includes computer instructions accessible by processor 1218 for enabling smartphone 502 to present a graphical user interface to the user, to receive input from the user and to transmit commands or data indicative of the commands through transceiver 1201. The graphical user interface may include configurable buttons, such as virtual buttons that appear on a display, to allow a user to make the selections disclosed above on interacting with the device social network.

Input/output module 1207 may be coupled to or part of a touch screen display to receive user input for application 1206. Network identification 1216 may be used by an access network within a distributed network to verify the rights of smartphone 502 to access the social media network. In operation, the disclosed embodiments may associate network identification 1216 with a user account for application 1206. In this way, network identification 1216 may not require the user to log in every time he launches application 1206.

The smartphone example disclosed in FIGS. 5 through 12 show that a device, not limited to a smartphone, may share details about applications or software on the device, the device itself, and any service connected to the device. This is important to note as, for example, a security system may provide details about customer satisfaction of the service within the device social network.

Using the disclosed embodiments, the user also may view applications, phones, carriers and other information by location. This location-sensitive information may view those users close to the user within the device social network to provide ranked recommendations or reviews.

It will be apparent to those skilled in the art that various modifications and variations can be made in the disclosed embodiments of the disclosed device and associated methods without departing from the spirit or scope of the invention. Thus, it is intended that the present invention covers the modifications and variations of the embodiments disclosed above provided that the modifications and variations come within the scope of any claims and their equivalents.

What is claimed is:

1. A computer-implemented method for exchanging information over a device social network, the method comprising:
authenticating a device of a user to access the device social network;
gathering allowed information from the device to be shared in the device social network;
storing information about the device to an online server connected to the device social network; and
sharing the information with at least one other device within the device social network based on a social network connection.

2. The method of claim 1, further comprising linking the device to a category unique to the device.

3. The method of claim 1, further comprising linking multiple users to a device.

4. The method of claim 2, wherein the category is associated to a channel within the device social network.

5. The method of claim 1, further comprising gathering the information about the device, wherein the information includes specifications of the device, programs or applications used by the device, performance details of the device and its parts, usage details of the device and its parts, or service details of the device and its parts.

6. The method of claim 1, further comprising of storing the information about the device associated with the user or users of the device.

7. The method of claim 1, further comprising of storing the information about the user associated with a device or multiple devices.

8. The method of claim 1, wherein the device is a smartphone, and the storing step includes storing information about at least one application on the smartphone.

9. The method of claim 1, further comprising sending a request to the at least one other device to join the device social network.

10. The method of claim 1, further comprising configuring a setting on the device to limit the information shared within the device social network.

11. A computer-implemented method for generating recommendations over a device social network, the method comprising:
generating a first set of recommendations of a program or application based on its usage, downloads, ratings, general feedback or market trends;
generating a second set of recommendations based on relevance of a program or application dependent on its on location, timing of the year, timing of the day and upcoming, ongoing or regular events; and
generating a third set of recommendations of devices, its parts, and services based on popularity, performance edge, cost effectiveness, promotions, location relevance, rating, general feedback, timing of the year, timing of the day or market trends.

12. The method of claim 11, wherein the device is a smartphone.

13. The method of claim 11, wherein the device is a connected device.

14. A device comprising:
a processor configured to access a memory, wherein the memory includes instructions executable by the processor to launch an application on the device, wherein the application configures the device to
authenticate the device to access a device social network;
gathering information on the device using an application; and
store information about the device to an online server connected to the device social network; and
share the information with at least one other device within the device social network based on a social network connection of the user.

15. The device of claim 14, wherein the application configures the device to receive information about the at least one other device within the device social network.

16. The device of claim 14, wherein the device and the at least one other device share a genre of devices.

17. The device of claim 14, wherein the device is a smartphone.

18. The device of claim 14, wherein the device is a connected device.

19. The method of claim 1, further comprising the step of selecting an operation using the application, wherein the operation causes information to be sent or retrieved over the device social network.

20. The method of claim 1, wherein the gathering step includes gathering specifications of the device, programs or application used by the device, performance details of the device, usage details of the device or service details of the device.
